(19) United States
(12) Patent Application Publication
(10) Pub. No.: US 2024/0210886 A1
(43) Pub. Date: Jun. 27, 2024

(54) ACTUATABLE EXTERNAL PARTS ELEMENT

(71) Applicant: Omega SA, Biel/Bienne (CH)

(72) Inventors: Antoine UMMEL, Neuchâtel (CH); Serge DROZ, Bôle (CH)

(73) Assignee: Omega SA, Biel/Bienne (CH)

(21) Appl. No.: 18/597,735

(22) Filed: Mar. 6, 2024

Related U.S. Application Data
(63) Continuation of application No. 17/657,443, filed on Mar. 31, 2022, now abandoned.

(30) Foreign Application Priority Data
Jun. 18, 2021 (EP) 21180380.4

(51) Int. Cl. G04B 37/02; G04B 37/10; G04B 43/00

(52) U.S. Cl. CPC G04B 37/02; G04B 37/10; G04B 43/005

(57) ABSTRACT

A Dewar device for mechanical and/or functional components of a watch, this device including a wristlet; a housing including a chamber wherein a case of the watch is capable of being disposed in such a way that a glass of this case is arranged facing a glass of a set of elements of the housing defining this chamber; at least one fastening device fastening this watch case in this chamber of the housing while maintaining it distant from this set of elements, and a device for actuating at least one control element of this watch by the movement in translation of an external parts element of the housing in the direction of a back of this housing.

### CROSS-REFERENCE TO RELATED APPLICATIONS

This application is a continuation of U.S. application Ser. No. 17/657,443 filed Mar. 31, 2022, which claims the benefit of priority from prior European Application No. 21180380.4 filed Jun. 18, 2021, the entire contents of each of which are incorporated herein be reference.

### TECHNICAL FIELD OF THE INVENTION

The present invention relates to a Dewar device for mechanical and/or functional components of a watch, the device comprising a device for actuating at least one control element of a watch arranged in a chamber of this Dewar device using an actuatable external parts element of this actuation device.

### TECHNOLOGICAL BACKGROUND

A watch and in particular an electronic watch conventionally comprises a wristlet and a watch case including several electric or electronic components. It is known in the prior art that some of these components do not support extreme temperatures, and stop functioning correctly at these temperatures. Typically, LCD liquid crystal displays using light emitting diodes or quartz tolerate temperatures not exceeding approximately 80° C. (degrees Celsius), and not going below 0° C. However, in particular environments for example such as space or lunar missions, the temperatures can frequently reach values of approximately substantially −150° C. to +125° C.

There is therefore a need to be able to use a watch in particular an electronic watch in environments in which there can be such extreme temperatures.

### SUMMARY OF THE INVENTION

The invention relates to a Dewar device for mechanical and/or functional components of a watch, said device comprising:
a wristlet;
a housing including a chamber in which a case of the watch is capable of being disposed in such a way that a glass of said watch case is arranged facing a glass of a set of elements of the housing defining this chamber;
at least one fastening device fastening said watch case in said chamber of the housing while maintaining it distant from said set of elements, and
a device for actuating at least one control element of said watch by the movement in translation of an external parts element of the housing in the direction of a back of this housing.

In other embodiments:
the actuation device comprises an external parts element of the housing configured to actuate said at least one control element during a performing of a movement in translation of said at least one external parts element in the direction of a back of this housing;
said external parts element is a bezel of the housing;
said external parts element is a glass of the housing;
said external parts element is a glass and bezel assembly of the housing;
said actuation device comprises at least one return element configured to return said at least one external parts element from an activated position to a deactivated position;
said external parts element comprises an actuation zone capable of activating said at least one control element of the watch by coming in contact with this said at least one control element;
said at least one control element of said watch is a push button or a crown, and
said chamber is under vacuum or almost under vacuum.

### BRIEF DESCRIPTION OF THE DRAWINGS

Other particularities and advantages will be clear from the following description that is made thereof, for informational and in no way limiting purposes, in reference to the following appended drawings:

FIG. 1 is a cross-sectional view of a diagram of a Dewar device for mechanical and/or functional components of a watch provided with a device for actuating at least one control element of a watch, according to an embodiment of the invention, and

FIG. 2 is a functional diagram of the Dewar device of the actuation device comprising an actuatable external parts element in a deactivated position, according to the embodiment of the invention, and

FIG. 3 is a functional diagram of the Dewar device of the actuation device comprising the external parts element in an activated position, according to the embodiment of the invention.

### DETAILED DESCRIPTION OF THE INVENTION

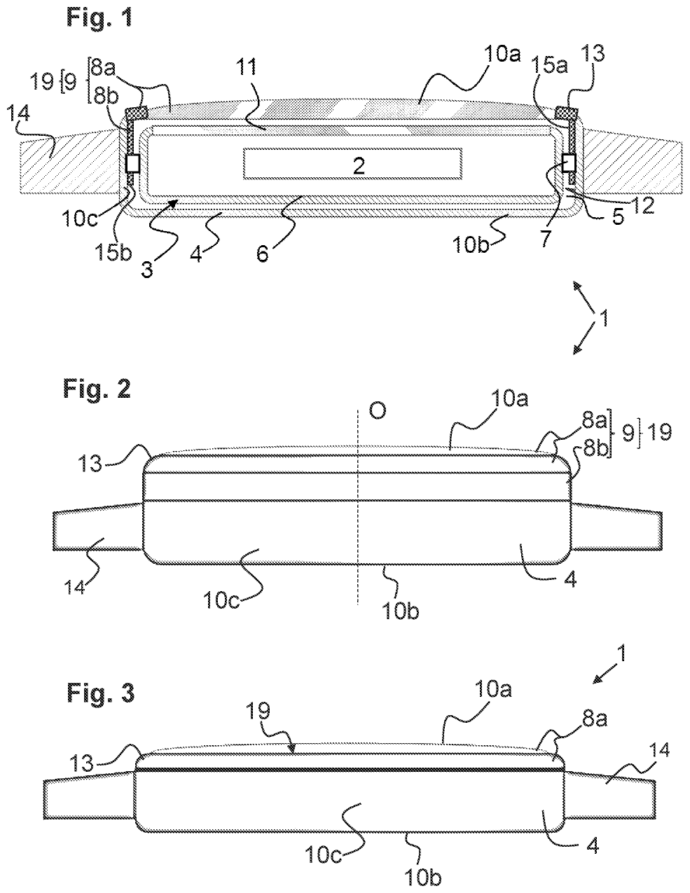

FIG. 1 shows a diagram of an isothermal horological device 1 for mechanical and/or functional components 2 of a watch 3 also called “horological Dewar device” or “protective device” or more simply in the rest of the description “Dewar device”. Such a Dewar device 1 is capable of participating in conferring in particular good thermal insulation onto mechanical and/or functional components 2 of the watch 3, the case 6 of which is arranged in the housing 4 of this device 1.

This Dewar device 1 is in particular formed by the combination of its housing 4 and of the watch 3 case 6 in order to create appropriate thermal insulation for these mechanical and/or functional components 2. In this configuration, the watch 3 case 6 is arranged in a chamber 5 of the housing 4 while being maintained distant or at a distance from all of the elements 10a to 10c of the housing 4 defining this said chamber 5 namely the glass 10a, an inner peripheral wall 12 of a middle 10c and a back 10b of this housing 4. It is noted that this inner peripheral wall 12 is also that of said chamber 5.

In this context, this device 1 thus comprises the housing 4 which includes the middle 10c preferably provided with two pairs of horns 14 on which a wristlet allowing a user of this device 1 to wear it for example on the wrist is mounted. This housing 4 also includes a back 10b visible in FIG. 1 as well as an actuatable external parts element 10a, 13, 9 such as a glass 10a that preferably comprises a surface that is substantially greater or strictly greater than a glass 11 of the watch 3 case 6.

This housing 4 is also provided with an external parts element 10a, 13, 9 such as a bezel 13 that can be mounted movably in rotation relative to the middle 10c. Such a bezel 13 has a substantially circular shape. It comprises a body having an outer face that can be provided with a graduation.

In reference to FIGS. 1 to 3, this Dewar device 1 also comprises a device 19 for actuating at least one control element of said watch 3 by the movement in translation of an external parts element 10a, 13, 9 of the housing 4 in the direction of a back 10b of this housing 4. Such an external parts element 10a, 13, 9 is preferably here a glass and bezel assembly 9. In such an assembly 9, the glass and the bezel of the housing 4 are mounted rigidly connected in particular to carry out the movement in translation mentioned above. In one alternative, this glass and the bezel together form a one-piece part.

In other alternatives, this external parts element 10a, 13, 9 can be the bezel 13 of the housing 4 or the glass 10a of this housing 4.

In this context, it is understood that this external parts element 10a, 13, 9 is configured to actuate this said at least one control element during a performing of a movement in translation of such a said at least one external parts element 10a, 13, 9 in the direction of the back 10b of this housing 4. Such a movement in translation is carried out in a direction that is parallel or substantially parallel to a central axis O of the housing 4.

This external parts element 10a, 13, 9 is capable of being moved between a deactivated position in which it is not in contact with the control element of said watch 3 and an activated position in which this external parts element 10a, 13, 9 actuates the control element of this watch 3.

In this Dewar device 1, the actuation device 19 also comprises a mechanism for controlling and guiding the external parts element 10a, 13, 9 from the deactivated position visible in FIG. 2 to the activated position visible in FIG. 3, and vice versa. This mechanism comprises in particular at least one return element configured to return said at least one external parts element 10a, 13, 9 from the activated position to the deactivated position.

As mentioned, this external parts element 10a, 13, 9 is mobile in translation relative to the middle 10c of the housing 4 of the Dewar device 1. Such an external parts element 10a, 13, 9 is mounted/assembled in a sealed or hermetic manner in the housing 4. In other words, the external parts element 10a, 13, 9 is connected/mounted/assembled in a sealed or hermetic manner to the middle 10c of this housing 4.

This external parts element 10a, 13, 9 comprises a first part 8a forming entirely or partly a bearing zone. This bearing zone is capable of receiving a pressure force exerted by the user of the Dewar device 1 on this external parts element 10a, 13, 9 in order to actuate at least one control element of the watch 3.

This external parts element 10a, 13, 9 also comprises a second part 8b extending substantially perpendicularly or strictly perpendicularly to the first part 8a in the direction of the back 10b of the housing 4. Such a second part 8b has a transverse cross-section having a shape substantially similar to a shape of a transverse cross-section of the middle 10c of the Dewar device 1. The transverse cross-section of this second part 8b has dimensions that are smaller than those of the transverse cross-section of the middle 10c. In other words, when the transverse cross-section of this second part 8b is circular, the diameter of this cross-section is thus smaller than that of the transverse cross-section of the middle 10c of the Dewar device 1. It is noted that these transverse cross-sections of this second part 8b and of the middle 10c are perpendicular or substantially perpendicular to the central axis O of the housing 4 of the Dewar device 1.

This second part 8b forms a peripheral wall 8b provided with at least one actuation zone capable of activating the control element of the watch 3 by coming in contact with the latter. This actuation zone can be for example arranged on an inner face 15a and/or a free end 15b of the peripheral wall 8b. Free end 15b means the part of this peripheral wall 8b that is arranged substantially or strictly facing the back 10b of the housing 4 of the Dewar device 1. Moreover, it is noted that this actuation zone is capable of coming in direct contact with said at least one control element of the watch 3. When this actuation zone is arranged on the inner face 15a it can comprise a protrusion that is capable of carrying out the actuation of the corresponding control element of the watch 3.

Such a peripheral wall 8b is capable of penetrating entirely or partly into the chamber 5 of the housing of the Dewar device 1 when the external parts element 10a, 13, 9 carries out a movement in translation towards the back 10b of the housing 4 in order to actuate said at least one control element. This peripheral wall 8b can penetrate into this chamber by sliding.

It is noted that this peripheral wall 8b can comprise at least one hollow in which a device 7 for fastening the watch 3 case that will be mentioned below can be arranged, when the external parts element 10a, 13, 9 is in the activated position.

It is understood that such an actuation device 19 allows to improve the use of the Dewar device 1 in particular when the user of this device 1 is not very dexterous with the part of their body that allows them to manipulate it. This lack of dexterity can result from a disability or from the fact that this user is wearing heavy gloves on their hands which prevent them from being precise with their fingers to manipulate this Dewar device 1. In this context, it is noted that such a Dewar device 1 is particularly adapted to a use by astronauts wearing their spacesuit or more generally by users/adventurers in a suit moving in environments in which there are extreme conditions in terms for example of pressure, temperature, humidity, etc.

As mentioned above, the watch 3 case 6 is arranged in the chamber 5 of the housing 4 while being maintained distant or at a distance from all of the elements 10a to 10c of this housing 4. This remoteness or this distance or this separation is configured on the basis of at least one device 7 for fastening the watch 3 case 6 comprised in the housing 4. In other words, the fastening device 7 is configured to carry out or maintain a separation between said case 6 and all of the elements 10a, 10b, 10c of the housing 4 forming said chamber 5 of this housing 4. This fastening device 7 participates in reducing or even in eliminating any thermal conduction between the inner peripheral wall 12a of the middle 10c and/or the back 10b and/or the glass 10a with the watch 3 case 6 in particular with an outer global face of this case 6. This outer global face includes an upper face comprising the glass 11 of the case 6 of this watch 3, a lower face comprising a back of said case 6 and an outer peripheral wall of a middle of this case 6. It is understood that the lower and upper faces are opposite to one another. It is noted that the fastening device 7 is arranged on an inner peripheral wall 12 of the chamber of the housing 4. In this configuration the fastening device 7 mechanically connects, in particular in a reversible manner, the watch 3 case 6 to the inner peripheral wall 12 of the chamber of the housing 4. Moreover, the Dewar device 1 can comprise two fastening devices 7 arranged in the chamber while being opposite to one another.

It is noted that such a case 6 is comprised in a watch 3 that can be an electronic watch for example a quartz watch, or a mechanical watch.

The mechanical and/or functional components 2 of the watch 3, mentioned above, comprise in a non-limiting and non-exhaustive manner: mechanical elements of the movement such as a balance-spring, wheels, a striking-work mechanism, a dial, hands, rings, joints and/or electronic and/or electric components 2. It is noted in particular that such electronic and/or electric components 2 include for example a display device, a processor, a memory, a component for storing energy, a motor, an integrated circuit and an electronic oscillator, etc.

It is thus understood that in this configuration, this Dewar device 1 has the same properties and characteristics as a Dewar tube/flask well known in the prior art. As mentioned above, the properties and characteristics of this Dewar device 1 participate in conferring onto it good thermal insulation with regard to temperatures, in particular extreme, that can exist in the outside environment in which such a device 1 can be located.

As mentioned, the glass 10a, the middle 10c and the back 10b of this device 1 together define the chamber 5 of this housing 4 which is capable of receiving the watch 3 case 6. These three elements 10a to 10c of the housing 4 namely the middle 10c, the glass 10a and the back 10b can be distinct elements that are joined together to build this chamber 5. Alternatively, the middle 10c and the back 10b of the housing 4 can together form a one-piece part, said one-piece part defining an opening opposite to the back 10b which is capable of being closed by the glass 10a, in a reversible and sealed manner. In one alternative, the middle 10c and the glass 10a of the watch 3 housing 4 can together form a one-piece part, said one-piece part defining an opening opposite to the glass 10a which is capable of being closed by the back 10b, also in a reversible and sealed manner.

The middle 10c or the back 10b can also be like the glass 10a transparent elements of the housing 4 of the Dewar device 1. In such a configuration, the peripheral wall 12 of the middle 10c and the inner face of the back 10b can be coated with a metallic reflective coating or similar, for example such as a layer of silver.

It is noted however that the middle 10c or the back 10b are preferably made in a non-limiting and non-exhaustive manner from a metal material or from thermosetting or thermoplastic polymer resins reinforced with carbon or glass fibres or from ceramic materials.

In addition, the device 1 can comprise an interferometric filter arranged on an outer global face of the housing 4 namely on an outer peripheral wall of the middle 10c and/or outer faces of the glass 10a and of the back 10b of this watch 3 case 6. This interferometric filter can be a grid or a netting forming a coating on this outer global face of the housing 4. This grid or netting has a mesh, the dimensions of which are such that they only let certain predetermined wavelengths of the electromagnetic spectrum pass through, typically the wavelengths of the visible range.

Moreover when the device 1 is provided to be used in an environment comprising air, the chamber 5 of the housing 4 comprising the watch case 6 is under vacuum or almost under vacuum. In other words, in this chamber, the space defined between this case 6 and the inner peripheral wall 12 of the middle 10c, the back 10b and the glass 10a is empty of material or almost empty. It is noted that when this device 1 is used in an environment devoid of air or substantially devoid, its chamber cannot be under vacuum, or on the contrary also be under vacuum or almost under vacuum.

Such a Dewar device 1, the use or the manipulation of which is facilitated via the actuation device, participates in providing the mechanical and/or functional components 2 of the watch 3 with very good thermal insulation with respect to the outside environment by reducing or even by preventing heat loss by radiation of the components arranged in the watch case 6 over a long duration. Thus, when the temperature outside the device 1 reaches extreme values, typically approximately −125 to +125° C., the temperature inside the chamber 5 remains substantially equal to the temperature present in the watch 3 case 6 during its arrangement in the housing 4, typically approximately 20° C. It is noted that regardless of the temperature conditions existing in the environment of the Dewar device 1, the temperature present in the watch 3 case 6 is a temperature that does not hinder the proper operation of the watch 3. This temperature is maintained over a duration that is 5 to 18 times greater than the duration for which such a watch 3 case would be capable of preserving an operating temperature of its components 2 while being located directly in such an environment in which there are such in particular extreme temperatures (that is to say while being located outside of the housing of the Dewar device). It is thus understood that such a configuration allows to protect the mechanical and/or functional components 2 of the watch 3, as well as participate in ensuring their operation in an optimal manner in extreme outside temperature conditions.

1. A Dewar device for mechanical and/or functional components of a watch, said device comprising:
a wristlet;
a housing including a chamber wherein a case of the watch is capable of being disposed in such a way that a glass of said case is arranged facing a glass of a set of elements of the housing defining said chamber;
at least one fastening device fastening said watch case in said chamber of the housing while maintaining it distant from said set of elements, and
a device for actuating at least one control element of said watch by the movement in translation of an external parts element of the housing in the direction of a back of said housing.

2. The Dewar device according to claim 1, wherein said actuation device comprises an external parts element of the housing configured to actuate said at least one control element during a performing of a movement in translation of said at least one external parts element in the direction of a back of said housing.

3. The Dewar device according to claim 1, wherein said external parts element is a bezel of the housing.

4. The Dewar device according to claim 1, wherein said external parts element is a glass of the housing.

5. The Dewar device according to claim 1, wherein said external parts element is a glass and bezel assembly of the housing.

6. The Dewar device according to claim 1, wherein said actuation device comprises at least one return element configured to return said at least one external parts element from an activated position to a deactivated position.

7. The Dewar device according to claim 1, wherein said external parts element comprises an actuation zone capable of activating said at least one control element of the watch by coming in contact with said at least one control element.

8. The Dewar device according to claim 1, wherein said at least one control element of said watch is a push button or a crown.

9. The Dewar device according to claim 1, wherein said chamber is under vacuum or almost under vacuum.
